(19) United States
(12) Patent Application Publication
(10) Pub. No.: US 2013/0168909 A1
(43) Pub. Date: Jul. 4, 2013

(54) CHOPPING BOARD FOR SLICED RAW FISH

(71) Applicant: Kazumi Miyawaki, Kyoto-shi (JP)

(72) Inventor: Kazumi Miyawaki, Kyoto-shi (JP)

(73) Assignee: AD Bank Limited Company, Shimogyo-ku, Kyoto-shi (JP)

(21) Appl. No.: 13/254,218

(22) PCT Filed: Feb. 28, 2011
(86) PCT No.: PCT/JP2011/054482

§ 371 Date: Sep. 1, 2011

(30) Foreign Application Priority Data
Aug. 9, 2010 (JP) 2010-178371

(51) Int. Cl. A47J 47/00

(52) U.S. Cl. CPC A47J 47/005
USPC 269/13; 269/295

(57) ABSTRACT

A chopping board for sashimi on which a block for sashimi can be sliced into pieces with substantially the same size (area) and weight neatly and easily even by those without any experience when the block is cut diagonally is provided.

A projecting stripe portion 21 is integrally formed on the top face of a chopping board 20, and angle-setting slits 22, in one of which a blade edge of a knife 1 is inserted, are formed in large number in this projecting stripe portion 21 in the lateral direction of the projecting stripe portion 21 at an interval corresponding to the thickness of one sashimi piece. Inclination of the angle-setting slit 22 on the perpendicular plane is set such that an inclination angle α with respect to a perpendicular base line 24 sequentially becomes larger and inclines to a head part side 17a as getting closer to a tail side 17b of the block 17 if the block 17 is placed on the top face of the chopping board 20 so as to have the head part side 17a on the right side. Inclination of the angle-setting slit 22 on the horizontal pane is formed such that an inclination angle β with respect to a horizontal base line 25 sequentially becomes larger and inclines to the head part side 17a as getting closer to the tail side 17b of the block 17.

### TECHNICAL FIELD

The present invention relates to a chopping board for sliced raw fish when fish is cut up and made into sashimi (sliced raw fish).

### BACKGROUND ART

In the fresh-fish handling industry, in the case of fresh fish stores, it is usually essential for store owners or professionals of those stores to be able to handle knives and be familiar with ways of cutting up various kinds of fresh fish. On the other hand, in food supermarkets, managers in charge of fresh fish can handle fish to some degree in order to instruct part-time workers, but in many cases, the next generation taking interest in fresh-fish handling are insufficient, and the present state is that a technology of fresh-fish cutting-up has not been passed down.

Moreover, in recent years, fresh fish for sashimi which is delivered to the supermarkets are generally fresh-fish blocks, and staffs in charge do not know how to kill live fish instantaneously or how to cut up fish, and it is taken for granted that they cannot even make sashimi.

FIG. 25 illustrates a scene in which a tuna block 52 is placed on a chopping board 51 and sashimi will be made by using a knife 1, and this block 52 is cut in advance into a substantially rectangular solid shape, and thus, only by inserting the knife 1 in the vicinity of positions shown as lines 53 in FIG. 26 and by simply slicing the block at a predetermined interval, sashimi having a certain constant thickness can be made. Also, since this block 52 has a substantially rectangular solid shape, areas of sliced fish pieces become substantially the same, and thus, part-time workers at fresh fish stores, supermarkets and the like and even housewives can easily make sashimi having the same size and the same thickness.

However, since the block 52 taken from large fish has a substantially rectangular solid shape as shown in FIG. 25, sashimi can be made easily as described above, but the shape of the block for sashimi is not always a rectangular solid. Some fish are small or even do not have a rectangular solid shape depending on the kind in many cases, and a fish block 54 as shown in FIG. 27 has a shape with the width narrowing from the body part to the tail and the thickness also thinning toward the tail.

If the block 54 as shown in FIG. 27 is sliced in the way similar to the case of the rectangular solid block 52 as shown in FIG. 28, even though the thickness can be made substantially the same, a sashimi piece 55a close to the head part of the body, a sashimi piece 55b at the center of the body, and a sashimi piece 55c close to the tail would have sizes (areas) and weights different from each other as shown in FIG. 29.

In general households, sashimi pieces with different sizes as shown in FIG. 29 would be all right, but such sashimi cannot be sold in fresh fish stores or supermarkets. The same applies to restaurants. It is needless to say that if sashimi pieces with different sizes are placed on a plate in a household, they do not look good or stimulate appetites, which might incur dissatisfaction from the family.

Even if the width dimension and thickness dimension are different depending on the spot in the block 54 as shown in FIG. 27, the block 54 should be sliced so that the size and weight become substantially the same, but this requires professionals with the skill to cut up the fish. This cutting up technique (slicing technique of the block 54) cannot be mastered easily and is said to require several years of training.

Though major supermarkets and restaurants can hire many workers with the professional skills, relatively small food supermarkets, restaurants, and fresh fish stores can only hire one worker with the skill at the most.

Also, as shown in FIGS. 25 and 26, if the rectangular solid shaped block 52 is sliced simply linearly, the block 52 can be sliced neatly, but if the knife is inclined diagonally so as to cut the block 52 and to increase the size (area) of each sashimi piece, it is extremely difficult to incline the knife by a certain angle all the time while cutting.

Thus, as a chopping board on which the block can be cut diagonally, Patent Literature 1 as described below can be cited.

### CITATION LIST

### Patent Literature

Patent Literature 1: Japanese Unexamined Patent Application Publication No. 2000-333852

The chopping board described in Patent Literature 1 is constituted by a square base plate with a groove at the center, a stable ruler having a slope with an appropriate inclination angle on the side face, and a square cooking base with a roller rotatably disposed at the end.

In Patent Literature 1, by placing a knife on the slope of the stable ruler and cutting the block, the block can be cut diagonally. However, when the block is to be cut, the cooking base is constructed to be moved by the roller with the block thereon, and an operation of slightly moving the cooking base and cutting the block while holding it needs to be repeated. Thus, it is cumbersome to manually move the cooking base for a given distance, and the block cannot be cut quickly, which causes a problem of poor workability. Also, moving the cooking base only by a given distance is not easy, and the thickness of each sliced sashimi piece is not the same.

Also, the chopping board in Patent Literature 1 is made up by three constituent members, that is, the base plate, the stable ruler, and the cooking base, and in order to cut the block, the cooking base and the stable ruler need to be combined with the base plate, and since the large stable ruler is located in front and hides the block, it causes a problem that the stable ruler obstructs a fish cutting-up work.

Though the function is different from that of a projecting stripe portion of the present invention, which will be described later, a chopping board having a projecting stripe on one face thereof is described in Patent Literatures 2 and 3 illustrated below, for example.

Patent Literature 2: Japanese Unexamined Patent Application Publication No. H08-56861

Patent Literature 3: Japanese Unexamined Patent Application Publication No. H09-220168

In Patent Literature 2, three projecting stripe portions parallel with each other and having a height of approximately 2 to 5 mm are disposed at an appropriate interval on the back face of a chopping board, a piece of cucumber or radish is located between the two projecting stripe portions, and by cutting it by a knife in that state, the cucumber can be cut in a bellows state or the radish can be cut in a connected state, which can be easily accomplished by those not having any experience.

Also, in Patent Literature 3, a projecting stripe member is disposed capable of sliding and rotating on a chopping board, this projecting stripe member is projected from the surface of the chopping board, and by putting the blade of a knife onto the projecting stripe member, a food material can be cut in circular slices without being cut away completely.

A chopping board used in such a way that the blade of a knife is inserted into a projecting stripe portion disposed on the top face of the chopping board is described in Patent Literature 4 shown below, for example.

Patent Literature 4: Japanese Utility Model Registration Application Publication No. S11-1118

In Patent Literature 4, a projecting stripe portion is formed on edge portions on the front and the other side of a chopping board, and guiding grooves are formed in a comb state at a predetermined interval along the lateral direction in the projecting stripe portions. A block is placed on the chopping board, and by cutting the block by a knife with the blade edge of the knife along the guiding groove, sashimi with the same thickness can be easily made.

### SUMMARY OF INVENTION

### Technical Problem

As described above, in Patent Literature 1, diagonal cutting of a block cannot be performed easily, and in the case of a block having a width getting narrower and a thickness also getting thinner toward the tail side, sashimi pieces with substantially the same size cannot be made.

Also, in Patent Literatures 2 and 3, a food material such as cucumber is cut in a partially connected state by using a projecting stripe portion, and an idea that a fish block is cut diagonally is not found in them.

Also, in Patent Literature 4, since the guiding groove depressed in the projecting stripe portion is not formed with inclination in the perpendicular direction or the horizontal direction, though sashimi pieces with the same thickness can be made, if the width gets narrower or the thickness gets thinner toward the tail side of the block as shown in FIG. 17, there still remains the problem that the block cannot be cut with the same size.

Thus, as described above, the size of sashimi becomes uneven, and a value as a commercial product is damaged when the sashimi is sold.

The present invention was made in view of the above problems and has an object to provide a chopping board for sashimi on which a block for sashimi can be cut neatly and easily with substantially the same size (area) and weight by even those without sufficient experience if a block with the width getting narrower and the thickness also getting thinner from a body part to the tail side of fish is to be sliced diagonally.

### Solution to Problem

A first aspect of the present invention is a chopping board 20 on which a block 17 for preparing for sashimi with the width getting narrower and the thickness also getting thinner from a body part of fish to a tail side 17b is placed and the block 17 is sliced by a knife 1 so as to make sashimi, characterized in that a projection stripe portion 21 is integrally formed over the whole length in the horizontal direction of the chopping board 20 on the top face of the chopping board 20;

a large number of angle-setting slits 22 into one of which the blade edge of the knife 1 is inserted are formed in the projecting stripe portion 21 at an interval corresponding to the thickness of one piece of sashimi in the horizontal direction of the projecting stripe portion 21;

a vertical line of the angle-setting slit 22 is set as a perpendicular base line 24 on a perpendicular plane;

a longitudinal line of the angle-setting slit 22 is set as a horizontal base line 25 on a horizontal plane;

inclination of the angle-setting slit 22 on the perpendicular plane is formed such that if the block 17 is placed on the top face of the chopping board 20 so as to have a head part side 17a on the right side, an inclination angle α with respect to the perpendicular base line 24 becomes sequentially larger so as to incline toward the head part side 17a as getting closer to the tail side 17b of the block 17; and

inclination of the angle-setting slit 22 on the horizontal face is formed such that if the block 17 is placed on the top face of the chopping board 20 so as to have the head part side 17a on the right side, an inclination angle β with respect to the horizontal base line 25 becomes sequentially larger so as to incline toward the head part side 17a as getting closer to the tail side 17b of the block 17.

A second aspect of the present invention is characterized in that guide grooves 27, each having the same inclination angle as the inclination angle β of the angle-setting slit 22 on the horizontal plane and guiding the blade edge of the knife 1, are depressed in the top face of the chopping board 20 in accordance with each of the angle-setting slits 22.

A third aspect of the present invention is characterized in that holes 29 through which drip, which is fish meat juice from the block 17, is dripped to the back face of the chopping board 20 are drilled in the chopping board 20 in a large number.

A fourth aspect of the present invention is characterized in that guide grooved 27, each having the same inclination angle as the inclination angle β of the angle-setting slit 22 on the horizontal plane and guiding the blade edge of the knife 1, are depressed in the top face of the chopping board 20 in accordance with each of the angle setting slits 22; and

the holes 29 through which drip, which is fish meat juice from the block 17, is dripped to the back face of the chopping board 20 are drilled in the chopping board 20 in a large number.

### Advantageous Effects of Invention

In the first aspect of the present invention, since the inclination of the angle-setting slit 22 on the perpendicular plane is formed such that if the block 17 is placed on the top face of the chopping board 20 so as to have the head part side 17a on the right side, the inclination angle α a with respect to the perpendicular base line 24 becomes sequentially larger and inclines toward the head part side 17a as getting closer to the tail side 17b of the block 17, and the inclination of the angle-setting slit 22 on the horizontal plane is formed such that if the block 17 is placed on the top face of the chopping board 20 so as to have the head part side 17a on the right side, the inclination angle β with respect to the horizontal base line 25 becomes sequentially larger and inclines toward the head part side 17a as getting closer to the tail side 17b of the block 17. Therefore, those other than professionals with fish cutting-up skills can easily change a swing angle of a blade 2 on the perpendicular plane and the horizontal plane by inserting the blade edge of the knife 1 in each of the angle-setting slits 22 of the projecting stripe portion 21 formed on the chopping board 20 and by cutting the block 17 as it is and can easily make neat sashimi pieces with substantially the same size and weight even in the case of the block 17 having the width getting narrower and the thickness also getting thinner toward the tail side 17b. Moreover, only by simply inserting the blade edge of the knife 1 from the angle-setting slit 22 on one end to the angle-setting slit 22 on the other end sequentially and by simply slicing the block, sashimi pieces with the same size can be cut, and thus, sashimi can be made in a short time and workability can be improved.

In the second aspect of the present invention, since the guide groove 27 that has the same inclination angle as the inclination angle β of the angle-setting slit 22 on the horizontal plane and guides the blade edge of the knife 1 is depressed in the top face of the chopping board 20 in accordance with each of the angle-setting slits 22, even if the blade edge of the knife 1 is separated away from the angle setting slit 22 while slicing the block 17, the blade edge follows the guide groove 27, and the block 17 can be cut. Thus, since the blade 2 does not swing laterally on the chopping board 20, the thickness of the sashimi piece does not change and sashimi pieces with the same thickness can be made in a short time neatly and easily.

In the third aspect of the present invention, since the holes 29 through which drip, which is fish meat juice from the block 17, is dripped to the back face of the chopping board 20 are drilled in the chopping board 20 in a large number, the drip from the block 17 is dripped to the back face of the chopping board 20 through the holes 29, and immersion of the lower face of the block 17 in the drip while the block 17 is cut up can be prevented as much as possible, and the taste of the block 17 can be maintained.

In the fourth aspect of the present invention, since the guide groove 27 that has the same inclination angle as the inclination angle β of the angle-setting slit 22 on the horizontal plane and guides the blade edge of the knife 1 is depressed in the top face of the chopping board 20 in accordance with each of the angle setting slits 22, even if the blade edge of the knife 1 is separated away from the angle-setting slit 22 while the block 17 is being sliced, the blade edge can follow the guide grove 27 and cut the block 17. Thus, since the blade 2 does not swing laterally on the chopping board 20, the thickness of the sashimi piece does not change and sashimi pieces with the same thickness can be made in a short time neatly and easily.

Also, since the holes 29 through which drip, which is fish meat juice from the block 17, is dripped to the back face of the chopping board 20 are drilled in the chopping board 20 in a large number, the drip from the block 17 is dripped to the back face of the chopping board 20 through the holes 29 and immersion of the lower face of the block 17 in the drip while the block 17 is cut up can be prevented as much as possible, and the taste of the block 17 can be maintained.

### BRIEF DESCRIPTION OF DRAWINGS

FIG. 1 is a plan view of fish when the fish is cut into three parts.

FIGS. 2A and 28 are a front view and a sectional view of one side of a body part when fish is cut into three parts.

FIGS. 3A and 3B are a front view and a sectional view of one side of a body part when fish has been cut into three parts.

FIG. 4 is a perspective view of a chopping board of a reference example.

FIGS. 5A and 5B are a plan view and a side view of the chopping board of the reference example.

FIGS. 6A and 6B are a front view and a rear view of the chopping board of the reference example.

FIG. 7 is an explanatory diagram of an inclination angle of an angle-setting slit of the reference example on a perpendicular plane and a horizontal plane.

FIG. 8 is an explanatory diagram of a chopping board of the reference example.

FIG. 9 is an explanatory diagram of when a block of the reference example is to be cut.

FIG. 10 is an explanatory diagram of when a block of the reference example is to be cut.

FIG. 11 is an explanatory diagram of when a block of the reference example is to be cut.

FIG. 12 is a perspective view of the chopping board of the reference example in which guide grooves are formed.

FIG. 13 is a plan view of the chopping board of the reference example in which the guide grooves are formed.

FIG. 14 is an enlarged sectional view of an essential part of the chopping board of the reference example.

FIG. 15 is a perspective view of the chopping board of the reference example in which the guide grooves and holes for dripping are formed.

FIG. 16 is a plan view of the chopping board of the reference example in which the guide grooves and holes for dripping are formed.

FIG. 17 is a perspective view of a chopping board of the present invention.

FIG. 18 is a plan view of a chopping board of the present invention.

FIG. 19 is a front view of a chopping board of the present invention.

FIG. 20 is an explanatory diagram of when a block of the present invention is to be cut.

FIG. 21 is an explanatory diagram of inclination angles of an angle-setting slit on the perpendicular plane and the horizontal plane of the present invention.

FIG. 22 is a plan view of the chopping board of the present invention in which guide grooves are formed.

FIG. 23 is a plan view of the chopping board of the present invention in which guide grooves and holes for dripping are formed.

FIGS. 24A to 24D are diagrams illustrating examples of other projecting stripe portions of the present invention.

FIG. 25 is a diagram of when sashimi is to be made in a prior-art example.

FIG. 26 is an explanatory diagram of when sashimi is to be made in the prior-art example.

FIGS. 27A and 27B are explanatory diagrams of when sashimi is to be made in the prior-art example.

FIG. 28 is an explanatory diagram of when sashimi is to be made in the prior-art example.

FIGS. 29A, 295 and 29C are explanatory diagrams after sashimi has been cut in the prior-art example.

### DESCRIPTION OF EMBODIMENTS

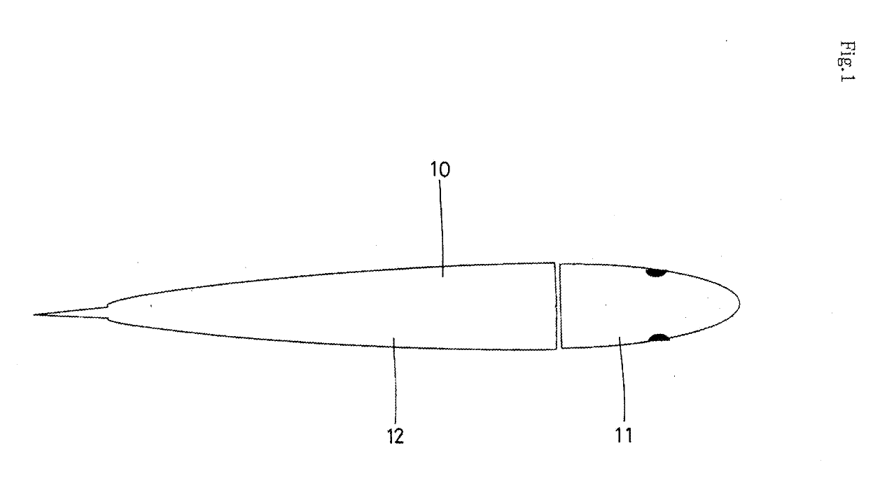

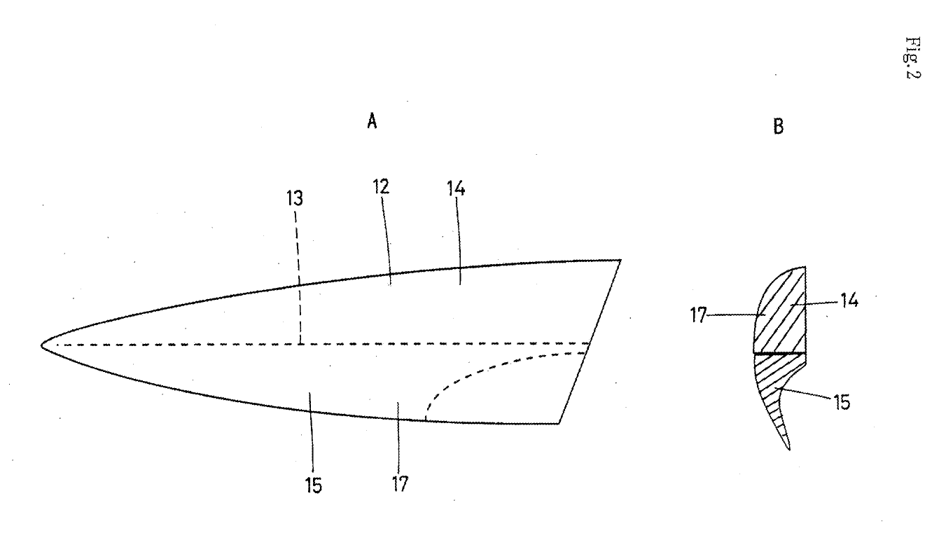

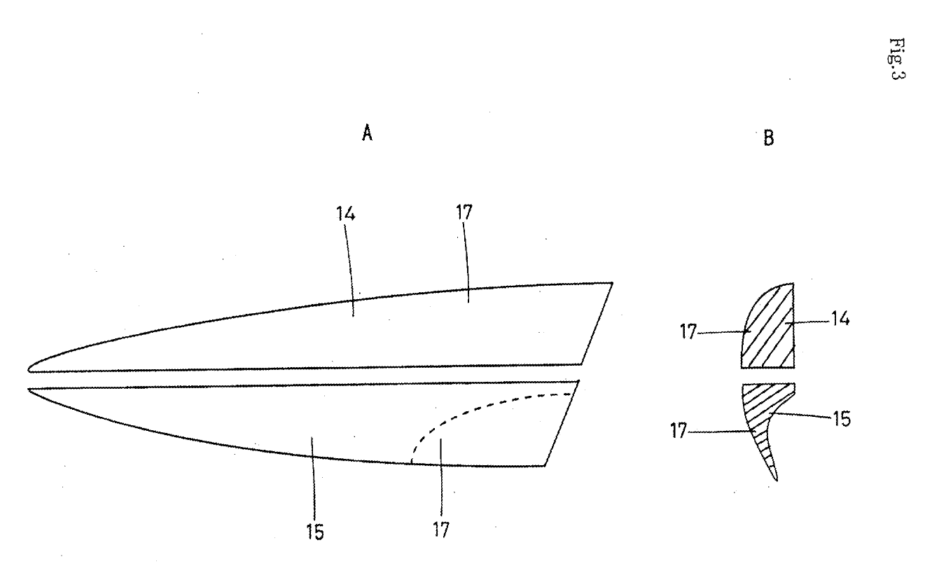

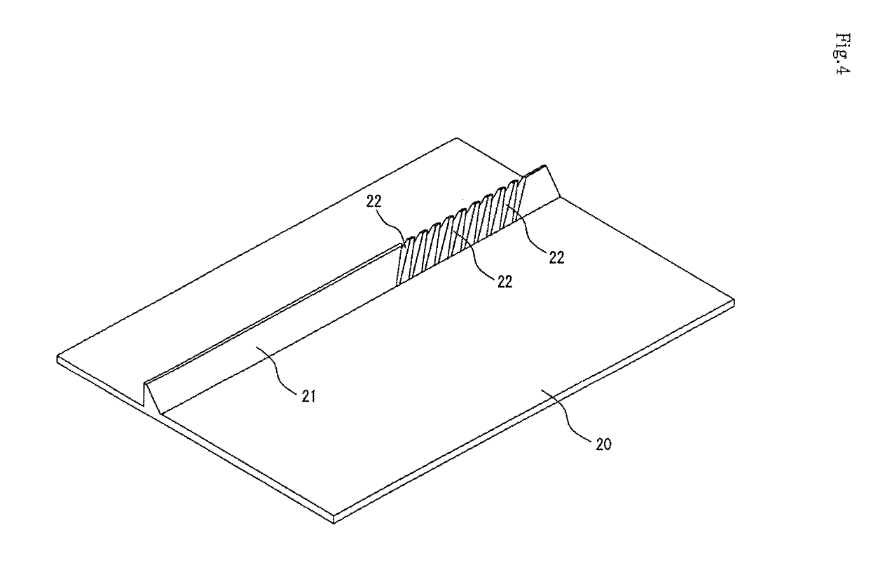

Before describing an embodiment of the present invention, a reference example (See FIGS. 4 to 16) will be described below. FIGS. 1 to 3 are diagrams of when fish 10 is cut into three parts, in which a head part 11 is cut off, and internal organs in a body part 12 are taken out. An upper side from a backbone 13 shown in FIG. 2 is a back meat 14, while a lower side from the backbone 13 is a belly meat 15. FIG. 3 is a diagram in which one side of the body part 12 is cut into the back meat 14 and the belly meat 15 along the longitudinal direction, and the one-side portion of the body part 12 shown in FIG. 2 and the back meat 14 portion and the belly meat 15 portion shown in FIG. 3 will be referred to as a block 17 for preparing for sashimi for convenience.

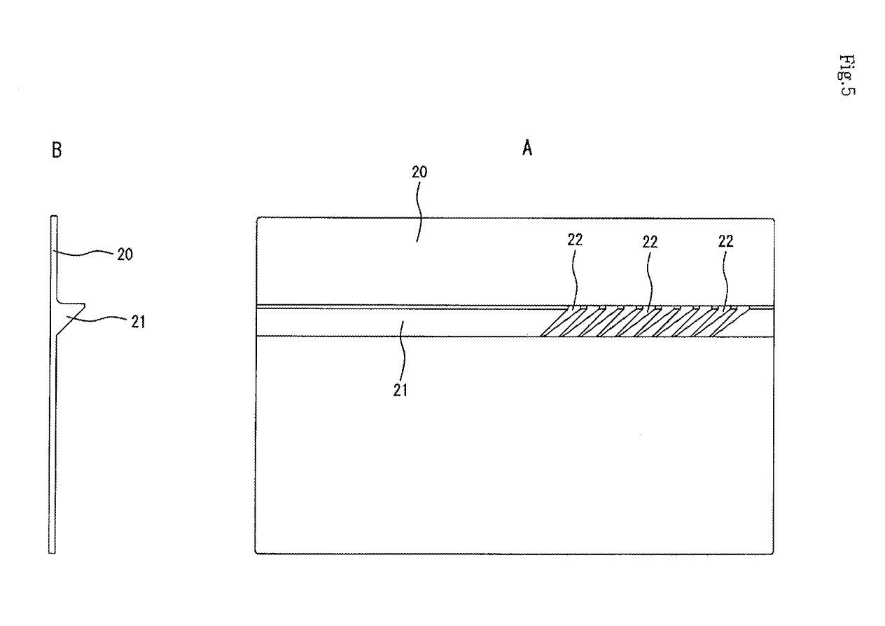

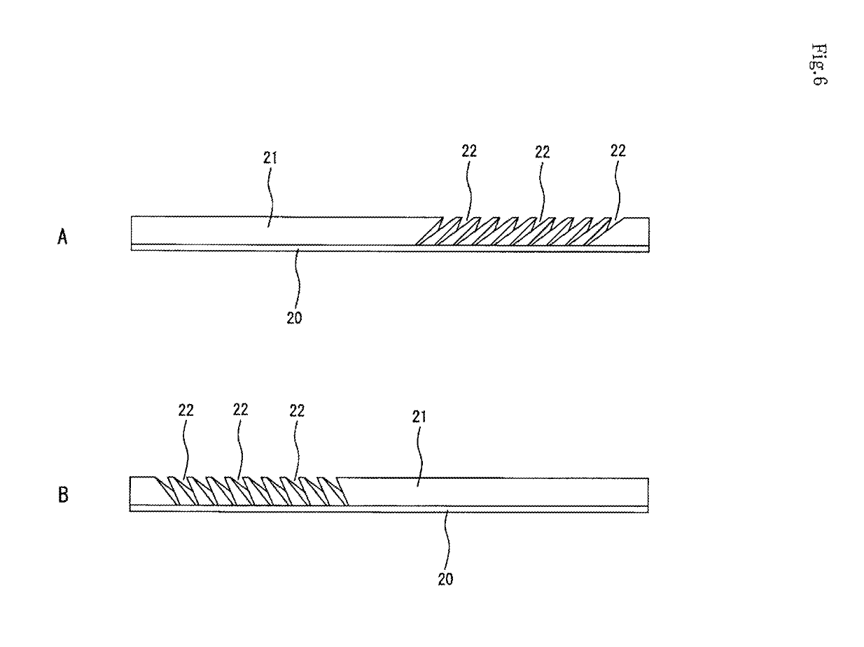

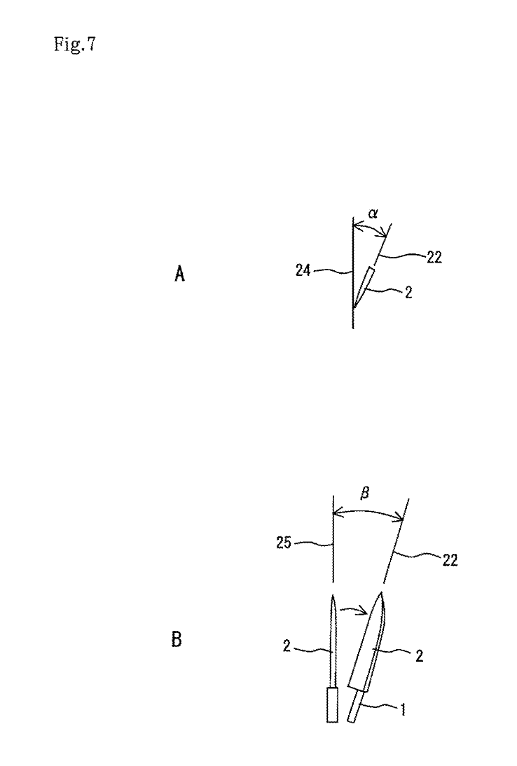

FIG. 4 shows a perspective view of a chopping board 20 for sashimi of the reference example, FIG. 5A shows a plan view of the chopping board 20, and FIG. 5B shows a side view of the chopping board 20, respectively. Also, FIG. 6A shows a front view of the chopping board 20, and FIG. 6B shows a rear view of the chopping board 20, respectively.

On the depth part side of the chopping board 20, a projecting stripe portion 21 having a substantially triangular section is integrally formed laterally over the whole length of the chopping board 20.

In the projecting stripe portion 21 of the chopping board 20, angle-setting slits 22 for setting inclination angles on the horizontal plane and the perpendicular plane of a blade of a knife when the block 17 is being sliced are continuously formed in a large number. This angle-setting slit 22 has a front face, a back face, and an upper face opened and has a substantially V-shape when seen from the front face. Also, an interval between the angle setting slits 22 is the thickness of one sashimi piece.

If the blade edge of the knife is inserted in this angle-setting slit 22, the blade is positioned on the perpendicular plane so as to incline by a certain angle and also positioned on the horizontal plane so as to incline by a certain angle at the same time.

FIG. 7 shows a state in which an inclination angle on the perpendicular plane and an inclination angle on the horizontal plane of the blade 2 of the knife 1 are determined by the angle-setting slit 22, in which FIG. 7A shows inclination of the perpendicular plane of the angle-setting slit 22 that determines inclination of the blade 2 of the knife 1 on the perpendicular plane. FIG. 73 shows inclination of the horizontal plane of the angle-setting slit 22 that determines inclination of the blade 2 on the horizontal plane.

Here, in FIG. 7A, a vertical line along which the blade 2 is lowered is referred to as a vertical base line 24, and in FIG. 7B, a longitudinal line on the horizontal plane is referred to as a horizontal base line 25. As shown in FIG. 7A, the angle-setting slit 22 is set on the perpendicular plane so that the blade 2 is inclined at an angle of α with respect to the perpendicular base line 24. At the same time, as shown in FIG. 7B, the angle-setting slit 22 is set on the horizontal plane so that the blade 2 is inclined at an angle of β with respect to the horizontal base line 25.

That is, if the blade edge of the knife 1 is inserted in the angle-setting slit 22, the inclination angles of the blade 2 on the perpendicular plane and the horizontal plane are automatically set by the angles α and β.

In this reference example, the inclination angles a of all the angle-setting slits 22 formed in the projecting stripe portion 21 are assumed to be the same, and the inclination angles β of all the angle-setting slits 22 are also assumed to be the same. The inclination angles α and β are set as appropriate to arbitrary angles, and the inclination angle α is set, for example, in a range of 30 to 60 degrees in the clockwise direction with respect to the perpendicular base line 24 when the chopping board 20 is seen from the front.

Also, the inclination angle β is set in a range of 20 to 45 degrees in the clockwise direction when the chopping board 20 is seen from the upper face. By setting the inclination angles α and β larger than 30 degrees, the size of one piece of sashimi from the rectangular solid block 17 can be made larger than the sectional area.

In this reference example, the inclination angle α is approximately 45 degrees and the inclination angle β is approximately 30 degrees. The numerical values of the inclination angles α and β are set in accordance with general angles when professionals cut up the block 17.

Also, if the angle-setting slits 22 are formed from the left side of the projecting stripe portion 21, the inclination angle α is an angle inclined in the counter-clockwise direction from the perpendicular base line 24, and the inclination angle β is also an angle inclined in the counter-clockwise direction from the horizontal base line 25.

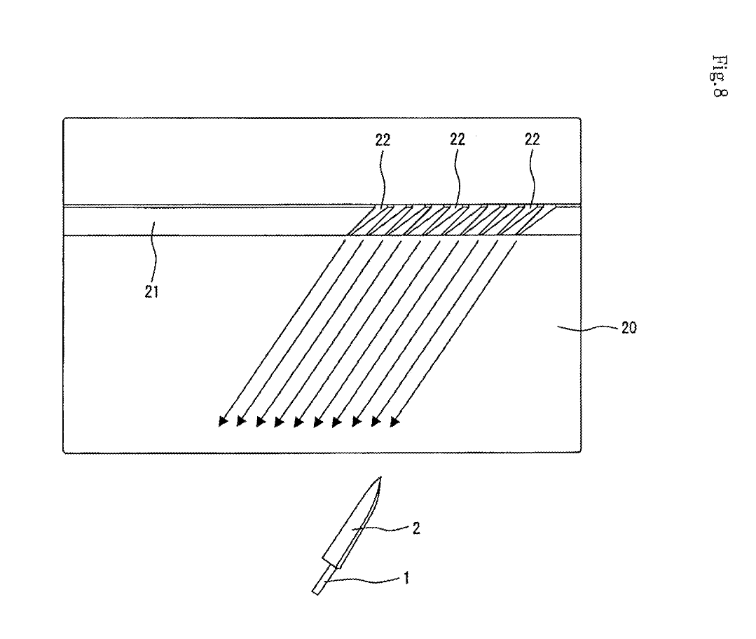

As described above, by inserting the blade edge of the knife 1 in the angle-setting slit 22 of the projecting stripe portion 21, the inclination angles on the perpendicular plane and the horizontal plane of the blade 2 when cutting the block 17 are set at the same time, and thus, by pulling the knife 1 with the blade 2 having inclination angles on the perpendicular plane and the horizontal plane determined toward the user as it is as shown in FIG. 8, the block 17 can be cut neatly as indicated by an arrow.

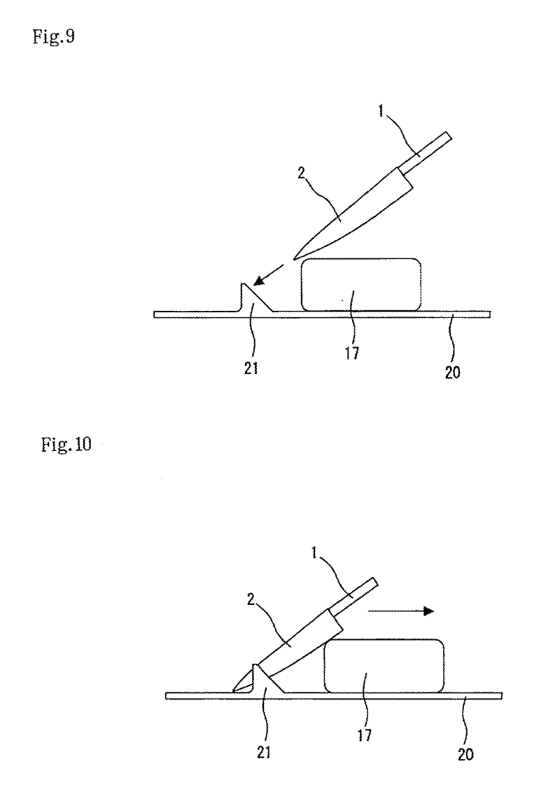

FIGS. 9 to 11 illustrate a situation in which the block 17 is placed on the chopping board 20 and the block 17 is cut by the knife 1. In a state in which the block 17 is placed on the chopping board 20, by inserting the blade edge of the knife 1 in the angle-setting slit 22 as shown in FIG. 9, the inclination angles on the perpendicular plane and the horizontal plane of the blade 2 are set at the same time as described above.

Then, in a state in which the inclination angles are determined, the block 17 is cut by pulling the knife 1 toward the user. Once the block 17 is cut, the blade edge of the knife 1 is inserted in the adjacent (or left, for example) angle-setting slit 22 again so as to determine the inclination angles of the blade 2, and the block 17 is cut by pulling the knife 1 toward the user as it is, similarly to the above.

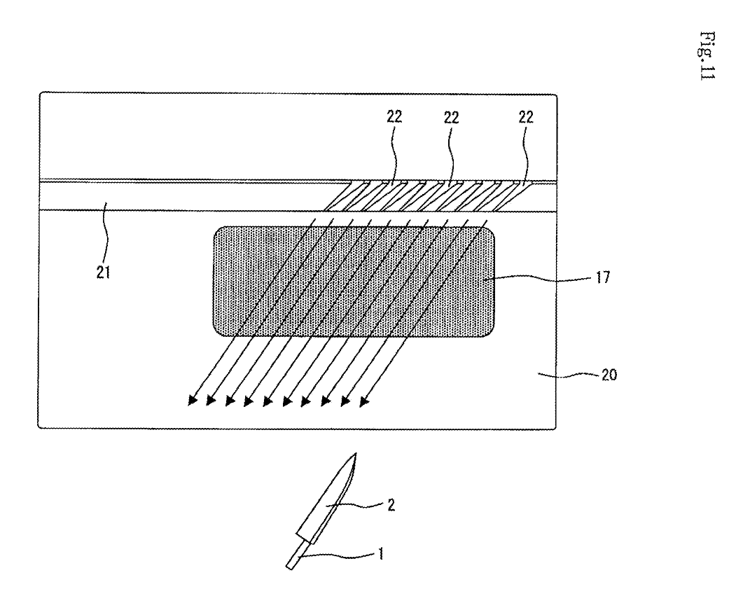

From the both side portions of the block 17 shown in FIG. 11, a sashimi piece with the same size as sashimi piece from the center portion cannot be taken. Thus, the both sides of the block 17 are not used as sashimi but used for other recipes including filling of chirashi-sushi (vinegared rice with pieces of raw fish, vegetables and the like on top), for example.

Also, in this reference example, an example in which ten angle-setting slits 22 are formed in the projecting stripe portion 21 is shown, but the number of the angle-setting slits 22 is not limited and a large number of the slits are formed in accordance with the lateral length of the chopping board 20.

As described above, in this reference example, only by inserting the blade edge of the knife 1 in the angle-setting slit 22 of the projecting stripe portion 21 on the chopping board 20, the inclination angles on the perpendicular plane and the horizontal plane of the blade 2 when cutting the block 17 are automatically set. Thus, only by pulling the knife 1 toward the user from the state in which the blade edge is inserted in the angle-setting slit 22 so as to cut the block 17, the block 17 can be sliced into sashimi pieces with a constant thickness diagonally cut with the inclination angles on the perpendicular plane and the horizontal plane.

As a result, those without any experience like fish-cutting professionals can make sashimi pieces with substantially the same size and weight neatly only by inserting the blade edge of the knife 1 in each of the angle-setting slits 22 of the projecting stripe portion 21 formed on the chopping board 20 and pulling the knife 1 toward the user as it is. Moreover, only by inserting the blade edge of the knife 1 sequentially from the angle-setting slit 22 on one end to the angle-setting slit 22 on the other end and by simply performing cutting, sashimi pieces with the same size can be cut and thus, sashimi can be made in a short time, and workability can be improved.

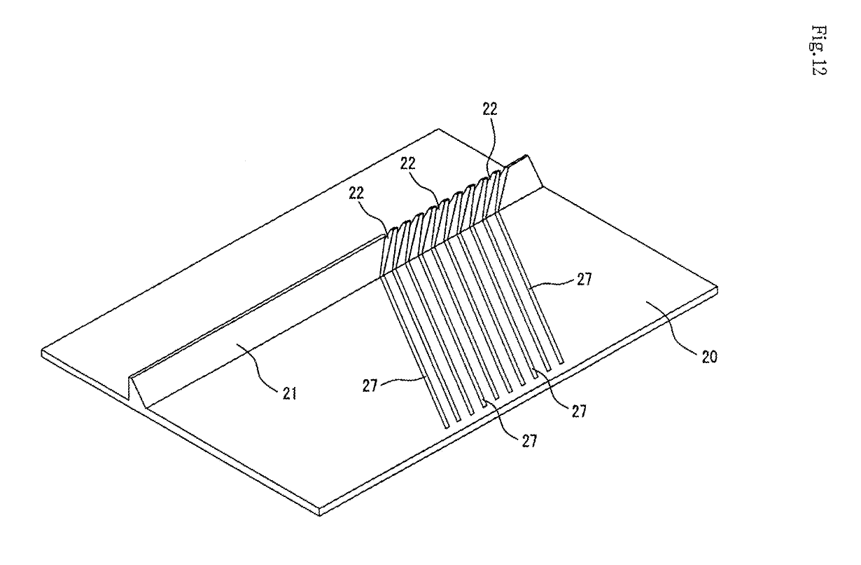

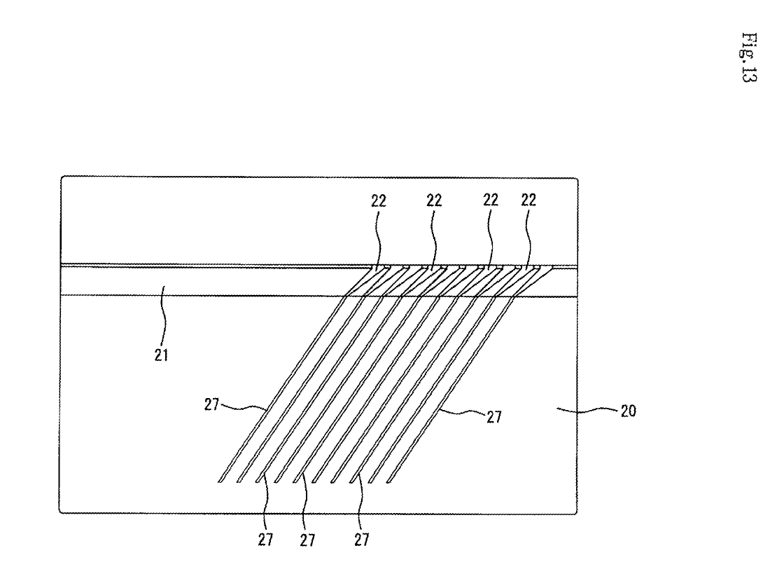

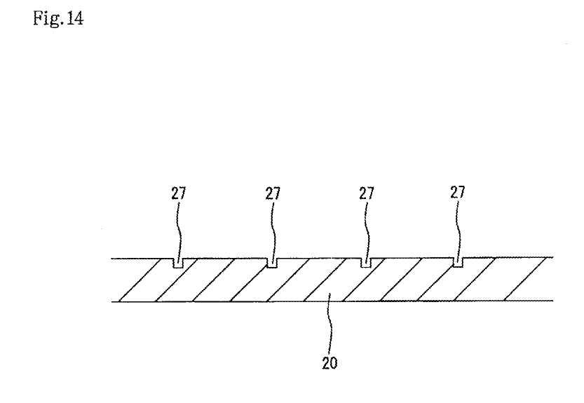

FIG. 12 shows a perspective view of the chopping board 20 in which the guide grooves 27, each guiding the blade edge of the knife 1 with respect to the chopping board 20 shown in FIG. 4 when block 17 is cut, are depressed, and FIG. 13 shows a plan view of the chopping board 20. Also, FIG. 14 shows an enlarged sectional view of an essential part of the chopping board 20.

The guide grooves 27 are disposed continuously from the lower end of each of the angle-setting slits 22, and as shown in FIG. 14, the bottom faces thereof are closed. Also, the inclination angle of the guide groove 27 is the same as the inclination angle β of the angle-setting slit 22 shown in FIG. 7B.

As described above, by disposing the guide grooves 27 corresponding to each of the angle-setting slits 22 on the top face of the chopping board 20, even if the blade edge of the knife 1 is separated away from the angle-setting slit 22 while cutting the block 17, the blade edge follows the guide groove 27 and can cut the block 17. Thus, since the blade 2 does not swing laterally on the chopping board 20, the thickness of the sashimi piece does not change and sashimi pieces with the same thickness can be made in a short time neatly and easily.

The bottom face of each of the angle-setting slits 22 formed in the projecting stripe portion 21 is flush with the top face of the chopping board, but the bottom face of the angle-setting slit 22 may be formed so as to be flush with the bottom face of the guide groove 27. In that case, the bottom part of the angle-setting slit 22 and the bottom part of the guide groove 27 communicate with each other, the blade edge of the knife 1 can be moved from the bottom part of the angle-setting slit 22 to the guide groove 27 further smoothly, whereby the block can be cut neatly.

After some hours or days have elapsed, red drip (fish meat juice) comes out from a block such as a back meat or belly meat, which is one of three parts cut from fish. If a block having been immersed in drip is to be prepared or a dripping block is to be prepared, taste of the block is damaged by the drip, and fish itself or sashimi tastes bad.

Thus, an example of the chopping board 20 having holes 29 for dripping is shown in FIGS. 15 and 16. FIG. 15 shows a perspective view of the chopping board 20 having the holes 29 disposed in the chopping board 20 shown in FIG. 12, and FIG. 16 shows a plan view of the chopping board 20 having the holes 29 disposed.

The holes 29 for dripping are, as shown in FIGS. 15 and 16, disposed in three rows by drilling a large number of holes in a straight state (perforated state).

By disposing a large number of these holes 29, drip from the block 17 can be dripped to the back face of the chopping board 20 through the holes 29, and immersion of the lower face of the block 17 in the drip while the block 17 is cut up can be prevented as much as possible, and the taste of the block 17 can be maintained. The shape of the hole 29 is a long hole in the illustrated example, but the shape is not limited to the long hole and may be circular.

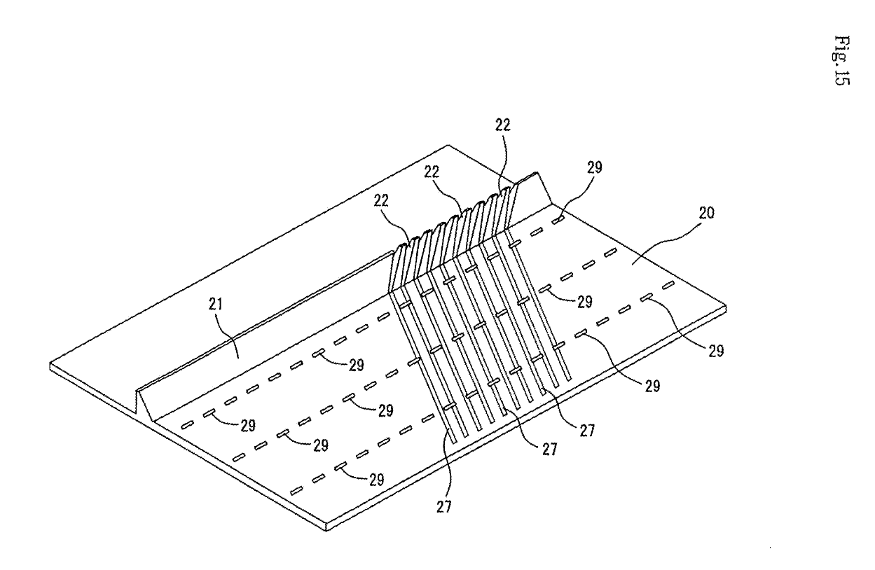

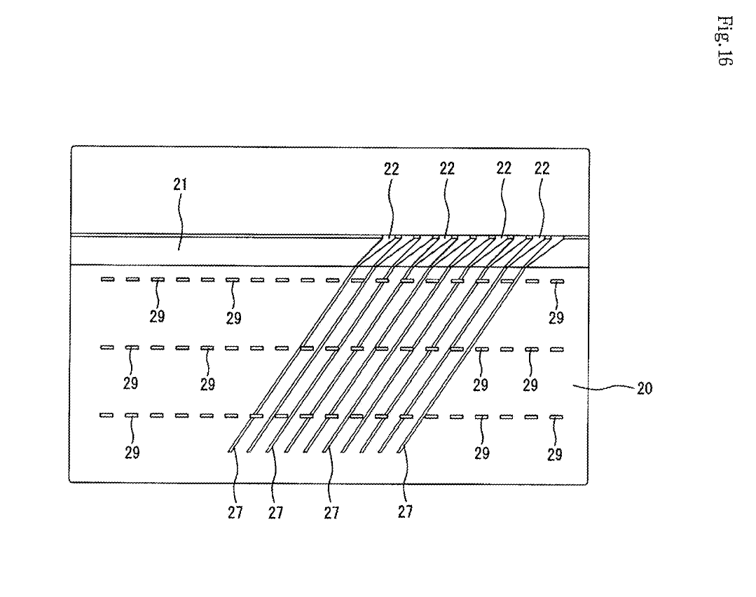

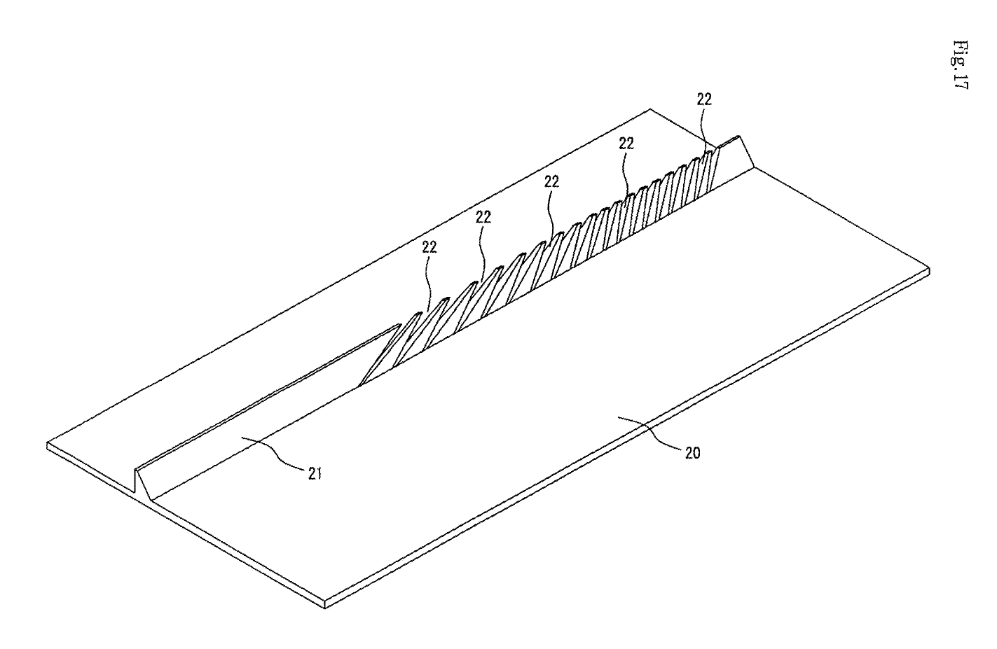

Subsequently, an embodiment of the present invention will be described in detail by referring to the attached drawings. That is, the chopping board 20 that can cut up the block 17 having a shape which becomes narrower in the width as well as thinner in the thickness toward the tail side will be described. FIG. 17 shows a perspective view of such chopping board 20, FIG. 18 shows a plan view, and FIG. 19 shows a front view, respectively. Also, FIG. 20 shows a state in which the above mentioned block 17 is placed on the top face of the chopping board 20.

In this embodiment, the projecting stripe portion 21 is formed on the top face of the chopping board 20 similarly to the above reference example and a large number of the angle-setting slits 22 are continuously formed on this projecting stripe portion 21 similarly to the above reference example. In the illustrated example, on the right side of the projecting stripe portion 21, ten angle-setting slits 22 having the same inclination angles α and β as shown in FIG. 4 are continuously formed, and the eleventh angle-setting slit 22 from the right and the subsequent slits have the inclination angles on the perpendicular plane and the horizontal plane gradually inclined.

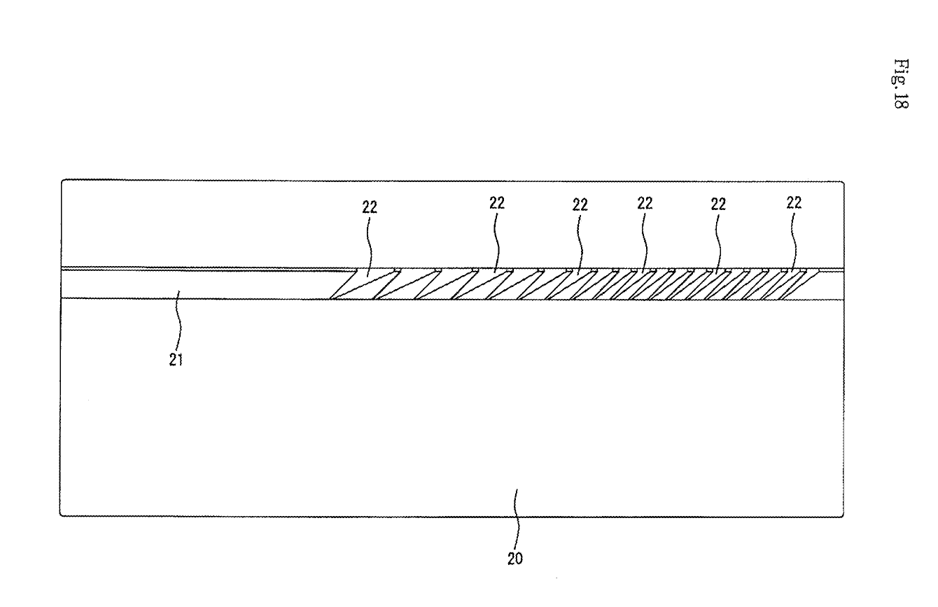

Subsequently, the inclination angles on the perpendicular plane and the horizontal plane of the angle-setting slits 22 on the left side will be described. FIG. 21 shows a state in which the inclination angle on the perpendicular plane and the inclination angle on the horizontal plane of the blade 2 of the knife 1 are determined by the angle-setting slit 22.

FIG. 21A shows inclination of the perpendicular plane of the angle-setting slit 22 that determines the inclination of the blade 2 of the knife 1 on the perpendicular plane, and FIG. 21B shows inclination of the angle-setting slit 22 on the horizontal plane that determines the inclination of the blade 2 on the horizontal plane.

Here, as shown in FIG. 20, the number of the angle-setting slit having the same inclination angle as shown in FIG. 4 is assumed to be “22”, the number of the angle-setting slit 22 on the left side of this angle-setting slit 22 as “225” for convenience, and the number of the angle-setting slit 22 on the leftmost side as “22A”.

As shown in FIG. 21A, the angle-setting slit 22 is set on the perpendicular plane so that the blade 2 is inclined with the angle of α3 (corresponding to shown in FIG. 7) with respect to the perpendicular base line 24 in the angle-setting slit 22. At the same time, as shown in FIG. 21B, the angle-setting slit 22 is set on the horizontal plane so that the blade 2 is inclined with the angle of β3 (corresponding to β shown in FIG. 7) with respect to the horizontal base line 25. The inclination angles on the perpendicular plane and the horizontal plane in the angle-setting slit 22 is the same as the case of the angle-setting slit 22 shown in FIG. 4.

Subsequently, in the angle-setting slit 22B, as shown in FIG. 21A, the inclination angle of the angle-setting slit 22B on the perpendicular plane corresponding to the inclination angle of the blade 2 in the perpendicular plane is set to an angle of αa2, which is larger than the above inclination angle α3 with respect to the perpendicular base line 24.

At the same time, as shown in FIG. 21B, the inclination angle of the angle-setting slit 22 on the horizontal plane corresponding to the inclination angle of the blade 2 in the horizontal plane is set to an angle of β2, which is larger than the inclination angle β3, with respect to the horizontal base line 25.

In the angle-setting slit 22A on the left end, as shown in FIG. 21A, the inclination angle of the angle-setting slit 225 on the perpendicular plane corresponding to the inclination angle of the blade 2 in the perpendicular plane is set to an angle of α1, which is larger than the inclination angle α2, with respect to the perpendicular base line 24.

At the same time, as shown in FIG. 21B, the inclination angle of the angle-setting slit 22 on the horizontal plane corresponding to the inclination angle of the blade 2 in the horizontal plane is set to an angle of β1, which is larger than the inclination angle β2, with respect to the horizontal base line 25.

As for each of the angle-setting slits 22 from the angle-setting slit 22B to the angle-setting slit 22A on the left end, each of the inclination angles α and β on the perpendicular plane and the horizontal plane are gradually inclined from the angles α2 and α2, and the inclination angles on the perpendicular plane and the horizontal plane at the angle-setting slit 22A on the left end are set to α1 and β1, which are the largest.

That is, in the angle-setting slit 22 on the right side, the inclination of the blade 2 on the perpendicular plane and the horizontal plane are set so as to have the angles of α3 and β3 in the angle-setting slit 22. From the angle-setting slit 22B on the left side to the angle-setting slit 22A on the left end of the angle-setting slits 22, the inclination of the blade 2 on the perpendicular plane and the horizontal plane are set so as to become gradually larger in each of the angle-setting slit 22.

That is, from the angle-setting slit 22 (22B) to the angle-setting slit 22 (22A), the inclination of the angle-setting slit 22 on the perpendicular plane is formed so that the inclination angle α with respect to the perpendicular base line 24 gradually becomes larger and incline toward the head part side 17a as getting closer to the tail side 17b of the block 17 when the block 17 is placed on the top face of the chopping board 20 so as to have the head part side 17a on the right side.

Also, the inclination of the angle-setting slit 22 on the horizontal plane is formed so that the inclination angle β with respect to the horizontal base line 25 gradually becomes larger and incline toward the head part side l7a as getting closer to the tail side 17b of the block 17 when the block 17 is placed on the top face of the chopping board 20 so as to have the head part side 17a on the right side.

Here, the inclination angle α in the angle-setting slit 22 is set at approximately 45 degrees and the inclination angle β at approximately 30 degrees similarly to the above, and the inclination angle α of the angle-setting slit 22A on the left end is approximately 75 degrees and the inclination angle β at approximately 60 degrees. It is needless to say that the inclination angles α and β are determined by the interval between the angle setting slits 22 or the number thereof, and the range of the inclination angle α of the angle-setting slit 22A on the left end is within a range of 70 to 80 degrees when the chopping board 20 is seen from the front and the inclination angle β is within the range of 50 to 70 degrees when the chopping board 20 is seen from the top.

As described above, in each of the angle-setting slits 22 on the right side, if the blade edge of the knife 1 is inserted in the angle-setting slit 22, the inclination angles of the blade 2 on the perpendicular plane and the horizontal plane are automatically determined to α3 and β3, and the block 17 is cut as shown by an arrow in FIG. 20 while the inclination angles of the blade 2 on the perpendicular plane and the horizontal plane are maintained.

Also, in the angle-setting slit 223 at the center part, if the blade edge of the knife 1 is inserted in the angle-setting slit 22, the inclination angles of the blade 2 on the perpendicular plane and the horizontal plane are automatically determined to α2 and β2, respectively, and the block 17 is cut while the inclination angles of the blade 2 on the perpendicular plane and the horizontal plane are maintained.

In the angle-setting slit 22A on the left end, if the blade edge of the knife 1 is inserted in the angle-setting slit 22, the inclination angles of the blade 2 on the perpendicular plane and the horizontal plane are automatically determined to α3 and β3, respectively, and the block 17 is cut while the inclination angles of the blade 2 on the perpendicular plane and the horizontal plane are maintained.

As described above, if the width of the block 17 is getting narrower and the thickness of the block 17 is getting thinner toward the tail side of the block 17, since the angle-setting slits 22 (22B to 22A) are formed so that the blade 2 of the knife 1 becomes sequentially inclined to the head part side 17a on the perpendicular plane and the horizontal plane as getting closer to the tail side 17b, the size and weight of each sashimi piece sliced to a predetermined thickness can be made substantially the same.

If the blade 2 of the knife 1 is inserted in each of the angle-setting slits 22, the inclination angles of the blade 2 on the perpendicular plane and the horizontal plane are automatically determined by each of the angle setting slits 22, and it is only necessary to pull the knife 1 toward the user and to cut the block 17.

As a result, even those without any experience like fish-cutting professionals can easily change the swing angle of the blade 2 of the knife 1 on the perpendicular plane and the horizontal plane by inserting the blade edge in each of the angle-setting slits 22 of the projecting stripe portion 21 formed on the chopping board 20 and by simply cutting the block 17 as it is and can easily make neat sashimi pieces with substantially the same size and weight even if the width of the block 17 gets narrower and the thickness gets thinner as getting closer to the tail side 17b side. Moreover, only by inserting the blade edge of the knife 1 sequentially from the angle-setting slit 22 on one end to the angle-setting slit 22 on the other end and by simply cutting the block, sashimi pieces with the same size can be sliced, and thus, sashimi can be made in a short time, and workability can be improved.

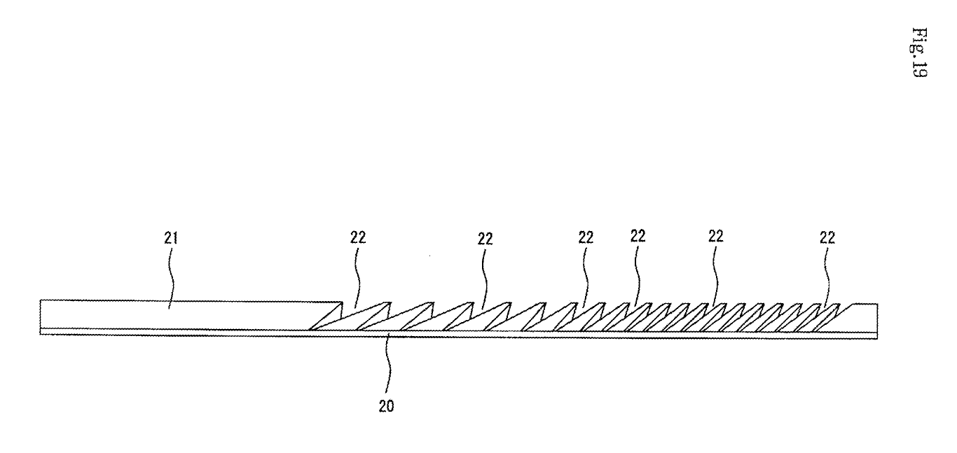

In FIG. 22, the guide grooves 27 are disposed in accordance with each of the angle-setting slits 22 similarly to the case in FIG. 12, and since the structure of the guide groove 27 is the same as in FIG. 12, detailed description will be omitted.

By means of these guide grooves 27, lateral swing of the blade 2 can be prevented, and sashimi pieces with substantially the same thickness can be cut.

In FIG. 23, three rows of the holes 29 for dripping are formed in the perforated state similarly to the case in FIG. 15. Since these holes 29 are disposed in a large number, drip from the block 17 is dripped to the back face of the chopping board 20 through the holes 29, and immersion of the lower face of the block 17 in the drip while the block 17 is cut up can be prevented as much as possible, and the taste of the block 17 can be maintained.

In the chopping board 20 shown in FIGS. 17, 22, and 23, the inclination angles on the perpendicular plane and the horizontal plane are gradually inclined from the angle-setting slit 22 in the middle, but the inclination angles on the perpendicular plane and the horizontal plane may be gradually inclined from the angle-setting slit 22 on the right end to the angle-setting slit 22 on the left end.

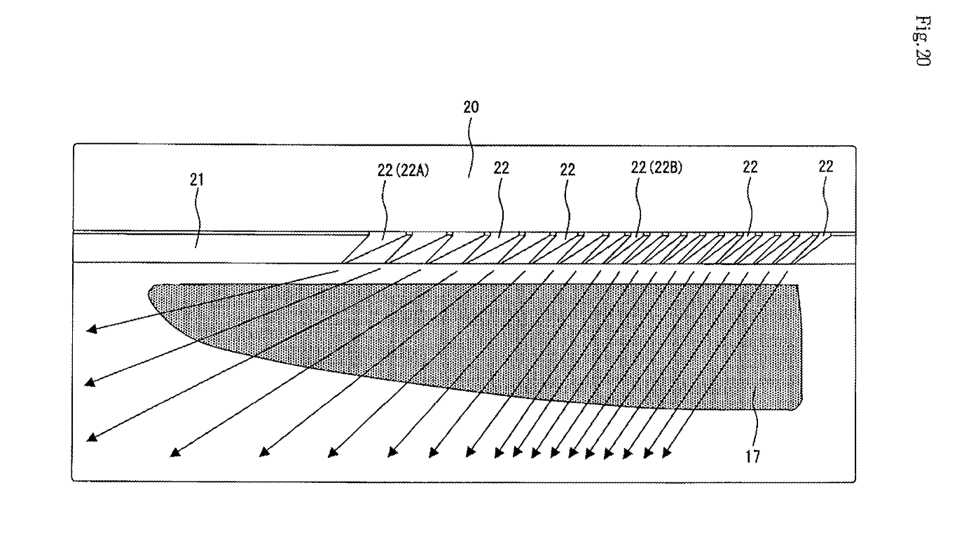

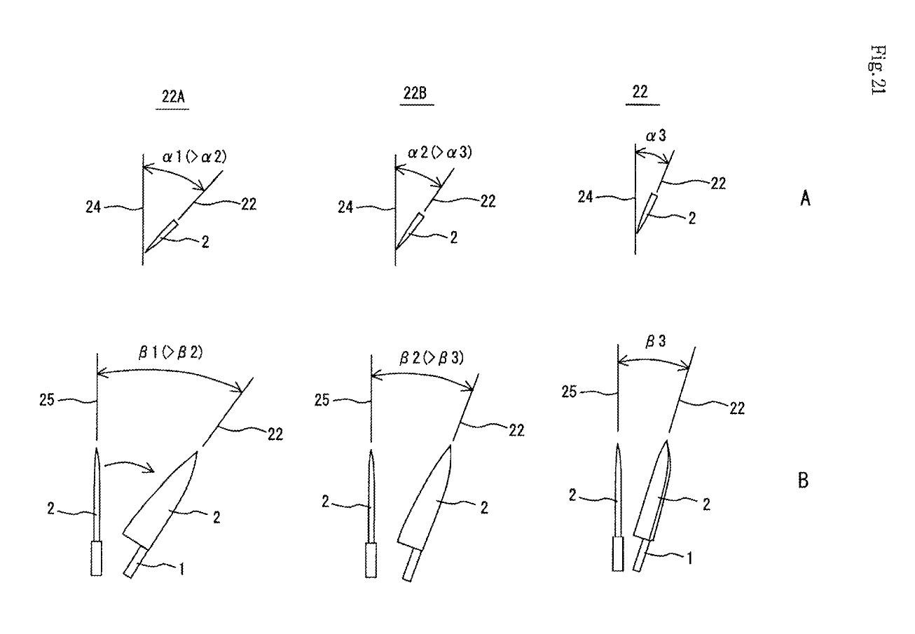

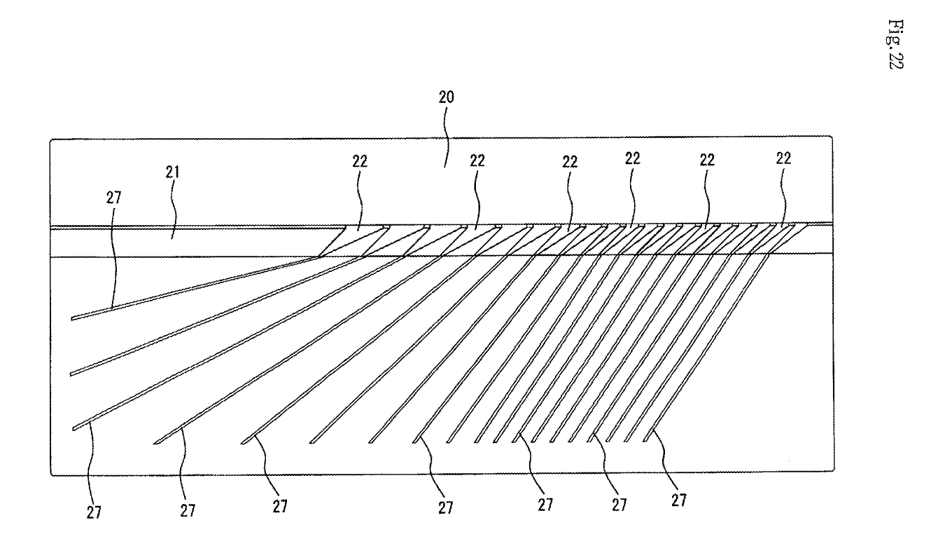

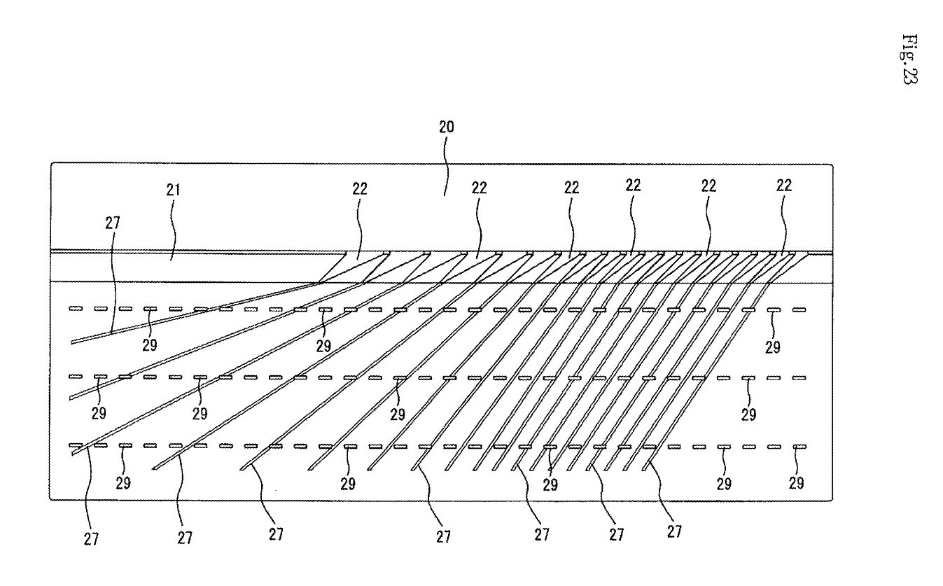

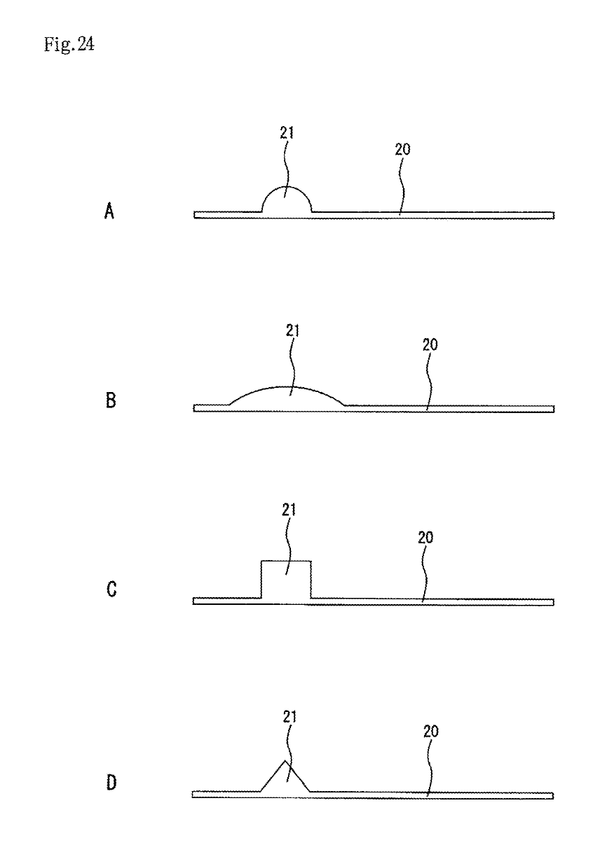

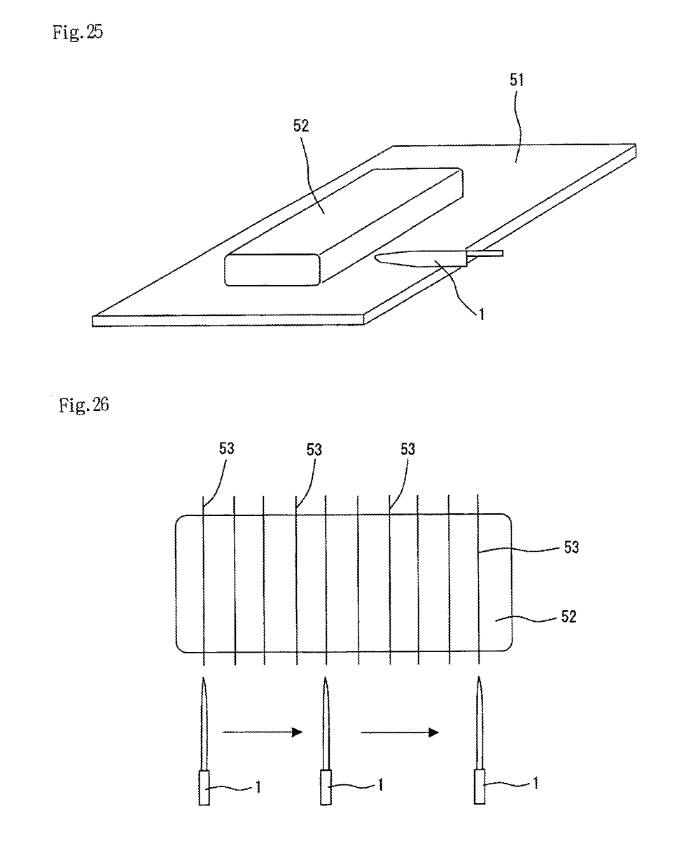

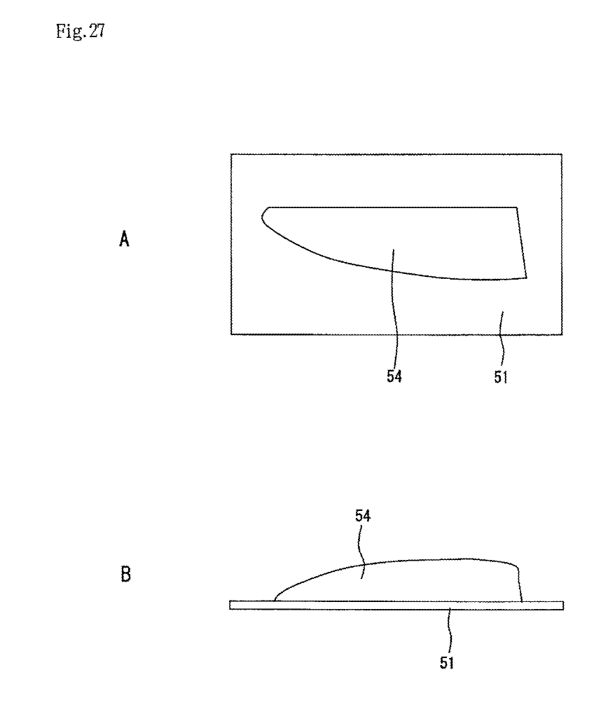

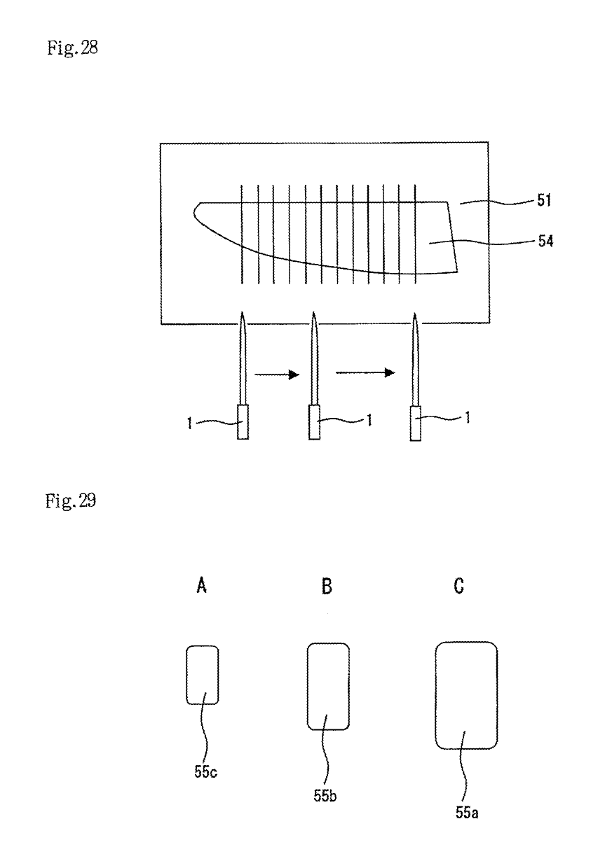

The projecting stripe portion 21 formed on the chopping board 20 has a triangular shape with a section on the back face side vertically straight in the above embodiment, but this shape is not limiting. For example, as shown in FIG. 24A, the section of the projecting stripe portion 21 may be a semicircular shape or it may be a gentle mountain shape as shown in FIG. 24B.

Also, as shown in FIG. 24C, the section of the projecting stripe portion 21 may be a square shape or as shown in FIG. 24D, the section of the projecting stripe portion 21 may be a triangular shape with a sharp upper part.

Also, in each of the above embodiments, the guide grooves 27 and the holes 29 are formed in the chopping board 20, but it may be so configured that the holes 29 for dripping are formed in the chopping board 20 without forming the guide grooves 27.

As a material of the chopping board 20, a thick paper material, plastic, a wood material and the like are used, and as the wood material, forest thinnings, for example, are used. Also, if the paper material is used, it may be synthetic paper having 51% of paper and 49% of polypropylene.

If the chopping board 20 is formed by a paper material or plastic, since the projecting stripe portion 21 is integrally formed in the rib shape, rigidity can be given to the chopping board 20, and even if the thickness is somewhat reduced, the chopping board 20 does not deflect.

### Reference Signs List

1 knife

2 blade

17 block

17a head part side of block

17b tail side of block

20 chopping board

21 projecting stripe portion

22 angle-setting slit

24 perpendicular base line

25 horizontal base line

27 guide groove

29 hole for dripping

α inclination angle

β inclination angle

1. A chopping board for sashimi, on which a block (17) for preparing for sashimi with the width getting narrower and the thickness also getting thinner from a body part to a tail side (17b) of fish is placed and the block (17) is sliced by a knife (1) so as to make sashimi, characterized in that
a projection stripe portion (21) is integrally formed over the whole length in the horizontal direction of said chopping board (20) on the top face of said chopping board (20);
a large number of angle-setting slits (22) into one of which the blade edge of said knife (1) is inserted are formed in said projecting stripe portion (21) at an interval corresponding to the thickness of one piece of sashimi in the horizontal direction of the projecting stripe portion (21);
a vertical line of said angle-setting slit (22) is set as a perpendicular base line (24) on a perpendicular plane;
a longitudinal line of said angle-setting slit (22) is set as a horizontal base line (25) on a horizontal plane;
inclination of said angle-setting slit (22) on the perpendicular plane is formed such that if said block (17) is placed on the top face of said chopping board (20) so as to have a head part side (17a) on the right side, an inclination angle (α) with respect to said perpendicular base line (24) becomes sequentially larger so as to incline toward the head part side (17a) as getting closer to the tail side (17b) of said block (17); and
inclination of said angle-setting slit (22) on the horizontal plane is formed such that if said block (17) is placed on the top face of said chopping board (20) so as to have the head part. side (17a) on the right side, an inclination angle (β) with respect to said horizontal base line (25) becomes sequentially larger so as to incline toward the head part side (17a) as getting closer to the tail side (17b) of the block (17).

2. The chopping board for sashimi according to claim 1, wherein
guide grooves (27), each having the same inclination angle as said inclination angle (β) of said angle-setting slit (22) on the horizontal plane and guiding a blade edge of said knife (1), are depressed in the top face of said chopping board (20) in accordance with each of the angle-setting slits (22).

3. The chopping board for sashimi according to claim 1, wherein
holes (29) for dripping, which is fish meat juice from said block (17), to the back face of said chopping board (20) are drilled in large number in the chopping board (20).

4. The chopping board for sashimi according to claim 1, wherein
guide grooves (27), each having the same inclination angle as said inclination angle (β) of said angle-setting slit (22) on the horizontal plane and guiding a blade edge of said knife (1), are depressed in the top face of said chopping board (20) in accordance with each of the angle-setting slits (22); and
holes (29) for dripping, which is fish meat juice from said block (17), to the back face of said chopping board (20) are drilled in large number in the chopping board (20).
